(19) United States
(12) Patent Application Publication
(10) Pub. No.: US 2014/0146038 A1
(43) Pub. Date: May 29, 2014

(54) AUGMENTED DISPLAY OF INTERNAL SYSTEM COMPONENTS

(71) Applicant: INTERNATIONAL BUSINESS MACHINES CORPORATION, Armonk, NY (US)

(72) Inventors: Paul D. Kangas, Raleigh, NC (US); Daniel M. Ranck, Apex, NC (US)

(73) Assignee: INTERNATIONAL BUSINESS MACHINES CORPORATION, Armonk, NY (US)

(21) Appl. No.: 13/686,987

(22) Filed: Nov. 28, 2012

(51) Int. Cl. G06T 19/00

(52) U.S. Cl. CPC G06T 19/006
USPC 345/419

(57) ABSTRACT

A mobile device identifies a physical computing system and retrieves a corresponding three dimensional model. The mobile device modifies an image of the model with real-time system information received from the physical computing system, and displays at least a portion of the modified image. The mobile device may display the modified image from the perspective of the mobile device in space relative to the physical computing system and adjusts the perspective as the mobile device is moved.

### FIELD OF THE INVENTION

The present invention relates generally to the field of augmented reality, and more particularly, to using augmented reality to examine a real-world computing system.

### BACKGROUND OF THE INVENTION

System maintenance requires knowledge of internal components to maintain the system and accurately diagnose problems. The most basic of known methods for examining a system is to physically open up the system to visually confirm components present and cable connections, read part numbers, etc. More advanced techniques include specialized system hardware and/or software that can provide the necessary system information to a user. For example, hardware-based service processors, also known as management processors, are microcontrollers or specialized processors designed to work with hardware instrumentation and systems management software to identify problems within a system. Service processors may also allow remote management of the system. Service processors may alert specified individuals when error conditions occur in a specific managed system. A service processor may allow a user to: monitor the system's sensors, view event logs, be apprised of faults, collect performance and fault information, and operate and/or manage the system remotely.

### SUMMARY

Embodiments of the present invention include a method, program product, and system for virtually seeing inside a computer system. A mobile device identifies a physical computing system. The mobile device retrieves a three dimensional model corresponding to the physical computing system, wherein the three dimensional model includes an arrangement of internal components. The mobile device receives real-time system information from the physical computing system. The mobile device modifies an image of the three dimensional model based on the real-time system information. The mobile device displays at least a portion of the modified image, including one or more internal components.

Other embodiments of the present invention include a method, program product, and system for navigating a display of a three dimensional model corresponding to a computer system. The mobile device displays an image of a three dimensional model corresponding to a computer system in line-of-sight with the mobile device, wherein the image of the three dimensional model is displayed from the perspective of the mobile device relative to the computer system. The mobile device detects movement of the mobile device. The mobile device, based on the detected movement, adjusts the image of the three dimensional model such that the image of the three dimensional model is displayed from a new perspective of the mobile device relative to the computer system. The mobile device, based on an image received at the mobile device of the computer system, synchronizes the displayed image to match the image of the computer system.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a diagnostic vision program for depicting internal components of a computing system, in accordance with an embodiment of the present invention.

FIG. 3 depicts a navigation program for displaying and navigating a three-dimensional augmented model of a physical computer system, in accordance with an embodiment of the present invention.

FIG. 4 depicts a mobile device displaying internal components of a server computing system, in an exemplary embodiment of the present invention.

FIG. 5 illustrates the modification of a displayed three-dimensional model based on diagnostic information, in an exemplary embodiment of the present invention.

FIG. 6 depicts the display of internal components of a failed component, in accordance with an exemplary embodiment of the present invention.

FIG. 7 depicts an alternate display of a selected component, including more detailed information of a sub-component in the system, e.g., part number, memory size, error messages, etc.

FIG. 8 illustrates the combination of an internal photo image and a three-dimensional model, in accordance with an embodiment of the present invention.

FIG. 9 depicts a block diagram of components of a mobile device, in accordance with an illustrative embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable media having computer readable program code/instructions embodied thereon.

Any combination of computer-readable media may be utilized. Computer-readable media may be a computer-readable signal medium or a computer-readable storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

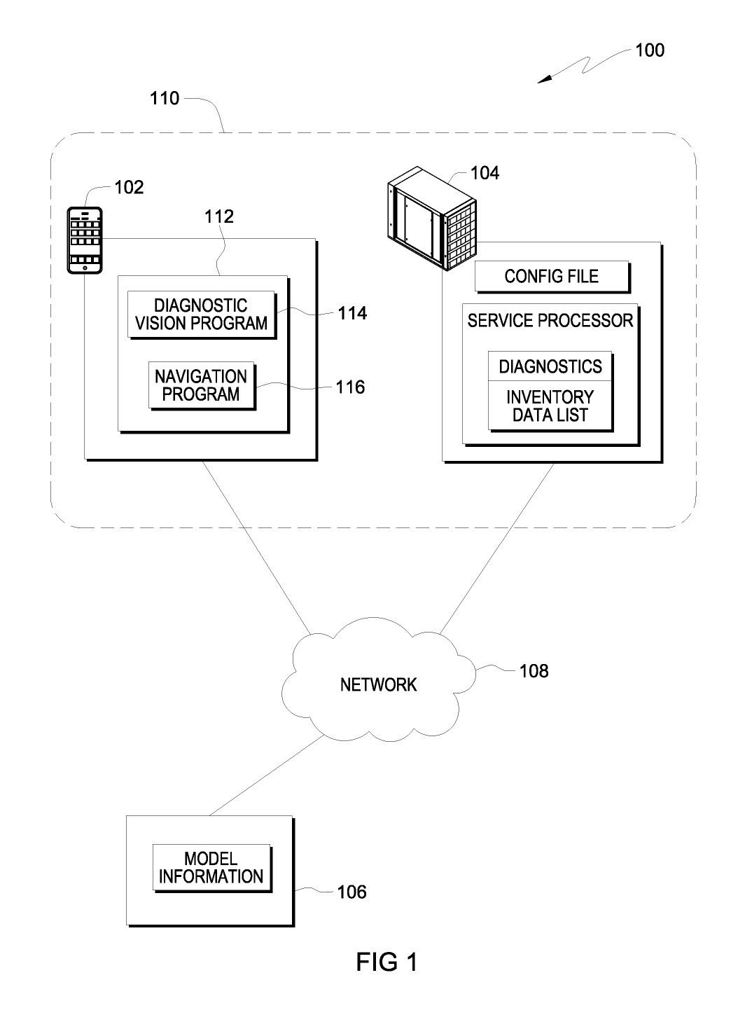

The present invention will now be described in detail with reference to the Figures. FIG. 1 is a functional block diagram illustrating a distributed data processing environment, generally designated 100, in accordance with one embodiment of the present invention. Distributed data processing environment 100 depicts mobile device 102, server computing system 104, and server computer 106, all interconnected by network 108. Mobile device 102 is in proximity with server computing system 104, depicted by grouped region 110. More particularly, mobile device 102 and server computing system 104 are in direct line of sight.

As depicted and discussed within the present description, server computing system 104 is a collection of server computers (e.g., blade servers) operating within a single enclosure or chassis. In other embodiments, server computing system 104 may be a workstation, laptop computer, desktop computer, or any other programmable electronic device capable of communicating with another electronic device, e.g., via network 108. Additionally, server computing system 104 stores and may communicate information descriptive of a current state of the system. Such information may include, but is not limited to, customer configuration (installed and/or detected components and locations), system diagnostics (stored, for example, in one or more log files), and an inventory data list (list of components that should be installed). In a preferred embodiment, a service processor in server computing system 104 can access such information, execute diagnostic reports, and communicate this information to mobile device 102. In other embodiments, any functionality that is capable of storing system information and performing diagnostics may be used.

On a very basic level, any number of programs are capable of creating a log file. A typical log file is a record of events (e.g., calculations, values, function calls, etc.) occurring in connection with one or more programs and/or in connection with one or more other operations of the computing system(s) for which the log files are maintained. The programs and/or files that generate the log files can be configured or customized to record any suitable information. The information may be utilized to, for example, diagnose a malfunctioning system, improve performance of a design, assess current operations(s), record one or more statistics, identify a problem, identify a source of the problem, etc. Log files, or information derived from log files, may be created and sent to a separate electronic device, such as mobile device 102 or server computer 106.

Mobile device 102 may be any mobile computing device capable of executing program instructions, communicating with other programmable electronic devices, capturing an image via a camera, and displaying an image to a user. For example, mobile device 102 may be a digital camera, a smart phone, a personal digital assistant (PDA), or a tablet computer. Mobile device 102 includes augmentation program 112. Augmentation program 112 utilizes a camera of mobile device 102 to capture an image of a physical computing system, e.g., server computing system 104, which may be displayed to a user of mobile device 102. Augmentation program 112 alters the image of server computing system 104 to provide the user a simulated “x-ray” image of server computing system 104, whereby the internal components of server computing system 104 are visible in the image displayed on mobile device 102.

Diagnostic vision program 114 is a sub-program or functionality of augmentation program 112 that identifies an image of a system, such as server computing system 104, retrieves a model of the system from a networked computer, e.g., server computer 106, and presents the model to the user on a display of the mobile device 102. Diagnostic vision program 114 further alters the displayed image by retrieving system information from the identified system, and updating the displayed image to represent the actual state of the system. The updated image may show missing components, failing components, and other points of interest and related information. In this manner, a user of mobile device 102 may, without opening up the system, view and assess the system's internal components.

Communication between mobile device 102 and server computing system 104, such as the retrieval of system information, may take place via network 108. Alternatively, communication between mobile device 102 and server computing system 104 may occur by way of near-field communication techniques such as RFID technology or Bluetooth™

Navigation program 116 is also a sub-program or functionality of augmentation program 112. Navigation program 116 allows for navigation of the displayed image. More specifically, navigation program 116 causes the augmented image to change perspective as mobile device 102 moves in relation to the physical system, such that mobile device 102 acts like a window into the system. Navigation program 116 may also allow for zooming in and out, and moving “inside” a selected component such that internal components of the selected component are depicted.

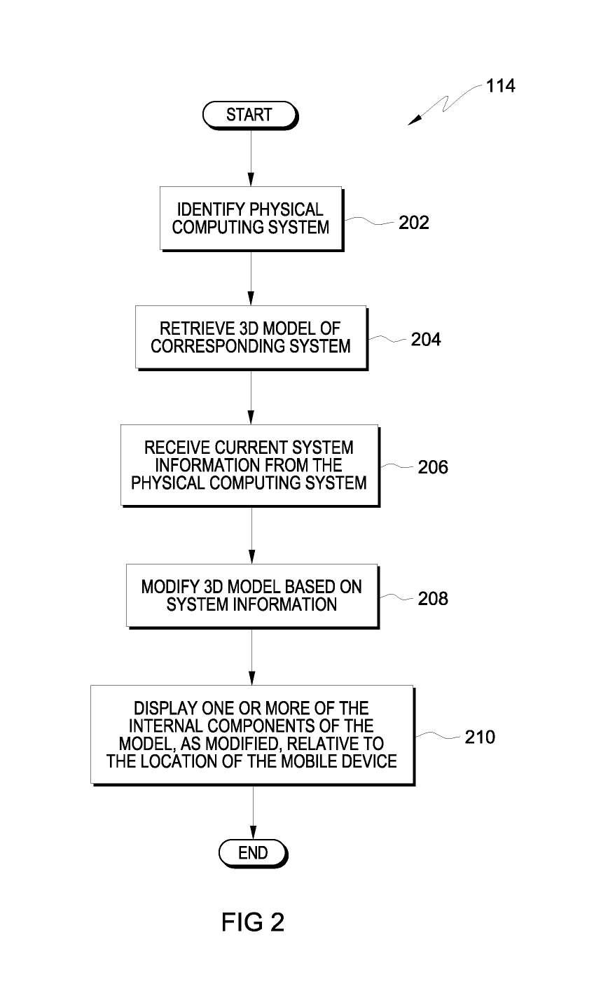

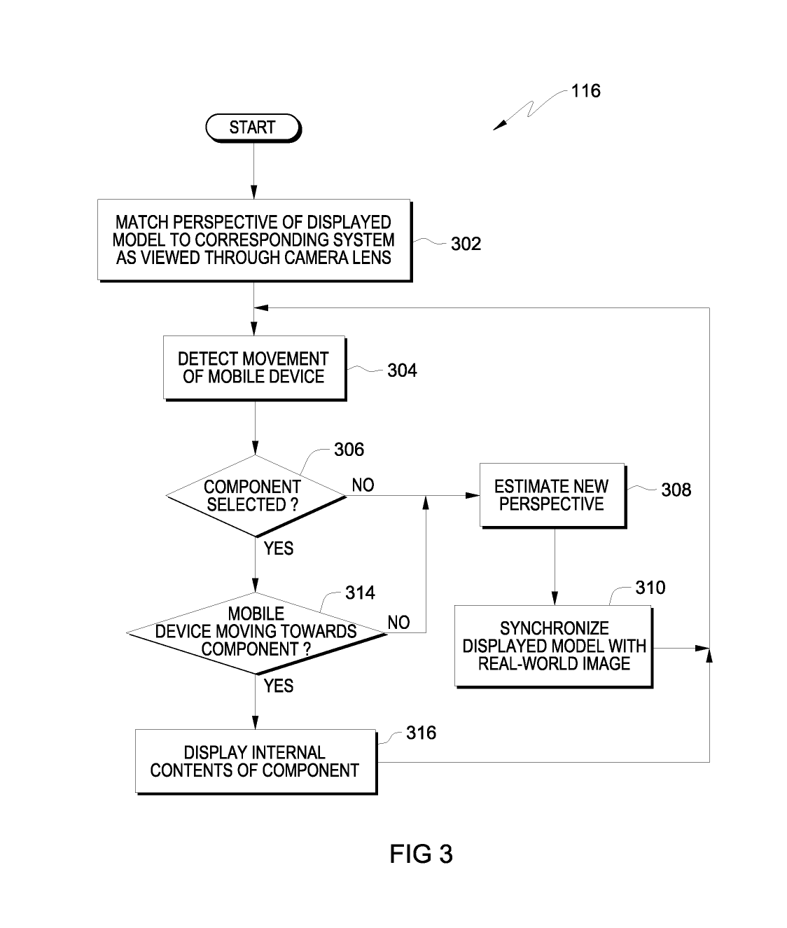

Exemplary implementations of diagnostic vision program 114 and navigation program 116 are discussed in more detail in relation to FIGS. 2 and 3, respectively.

Server computer 106 is a network computer capable of hosting three-dimensional models of various systems. In an alternative embodiment, server computer 106 represents a “cloud” of computers interconnected by one or more networks, where server computer 106 is a primary server for a computing system utilizing clustered computers and components to act as a single pool of seamless resources when accessed through network 108. This implementation may be preferred for data centers and grid and cloud computing applications.

In one embodiment, server computer 106 may receive images from mobile device 102 and, using known image recognition techniques, identify a system or object within the image and return a three-dimensional model corresponding to the identified system.

Network 108 may include connections such as wiring, wireless communication links, fiber optic cables, and any other communication medium. In general, network 108 can be any combination of connections and protocols that will support communications between mobile device 102, server computing system 104, and server computer 106.

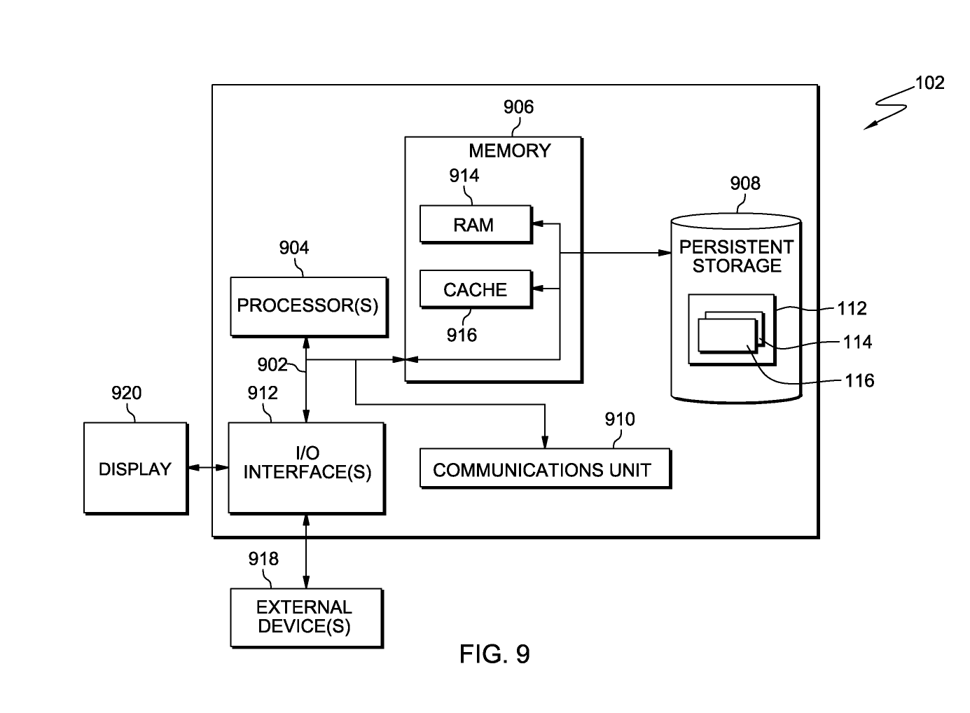

Mobile device 102 may include internal and external hardware components, as depicted and described in further detail with reference to FIG. 9.

FIG. 2 is a flowchart depicting operational steps of diagnostic vision program 114 for depicting internal components of a computing system, in accordance with an embodiment of the present invention.

Diagnostic vision program 114 begins by identifying a physical computing system (step 202). Diagnostic vision program 114 receives an image of server computing system 104 via a camera embedded or attached to mobile device 102. In one embodiment, diagnostic vision program 114 may use photo recognition algorithms to match the image to a known system or type of system. However, due to limited processing and storage capacity on a mobile device, at least as compared to a larger computing system (e.g., a grid environment or cloud computing environment), in a preferred embodiment diagnostic vision program 114 forwards the image to a designated system (e.g., server computer 106) to perform the analysis. Due to the variability of a received image (closeness, angle, etc.), diagnostic vision program 114 may use photo recognition to identify distinctive markings, such as a model or part number label or serial number, and use this information to match the image to a known system.

In an alternative embodiment, diagnostic vision program 114 may establish a connection with server computing system 104, through network 108 or via a near-field communication technology, and query server computing system 104 for a model number, serial number, or other identifier.

After identifying the physical computer system, diagnostic vision program 114 retrieves a three-dimensional model corresponding to the system (step 204). Companies often produce CAD models during the development phase for computer systems in production. Additionally, when a computer system is designed, engineering drawings are often created for the development of the system. The engineering drawings are typically three-dimensional models, and accurately depict the components of the system as arranged in a standard setup. In one embodiment, mobile device 102 may be registered with a service hosting a number of such models and may connect with the service via network 108 to request the models. As depicted in FIG. 1, these models may be stored on server computer 106. In an alternate embodiment, the forwarding of images to match a known system may also act as a request for corresponding models. For example, when a match is found on server computer 106 for an image or isolated descriptive element received from mobile device 102, server computer 106 may return the corresponding model in addition to, or as an alternative to, the identity of server computing system 104. In yet another embodiment, the three-dimensional models may be stored locally on mobile device 102.

In addition to the three-dimensional model, diagnostic vision program 114 also receives real-time or current system information from the physical computing system (step 206). The received three-dimensional model may provide an expected assembly of the system that the physical computing system is identified as, but presents an indirect representation of the internal system and cannot anticipate deviations to the expected arrangement and cannot add information specific to the state of the actual existing computer system. In one embodiment, a connection is established between mobile device 102 and server computing system 104 to request current system information. Current system information may include, in various embodiments, inventory data, configuration data, diagnostic data, and even live picture or video feeds from within server computing system 104.

In a preferred embodiment, existing service processor technology may be leveraged to provide system information to mobile device 102. Mobile device 102 may be registered with the service processor as an administrator, and may have access to the services provided by a service processor including access to inventory lists, configuration files, event logs, and diagnostic data. As an added benefit, many service processors are operational as long as the system is attached to a power source, without the need for the system to be “on”. In other embodiments, mobile device 102 may query database storage and log files for the desired system information without the benefit of a service processor.

Based on the received system information, diagnostic vision program 114 modifies the three-dimensional model (step 208). For example, diagnostic vision program 114 may receive an inventory data list identifying components that server computing system 104 is supposed to have. Based on this list, internal components of the three-dimensional model may be added or removed to match the inventory of server computing system 104.

Based on received customer configuration data, diagnostic vision program 114 may determine that various internal components are arranged differently and modify the model to reflect this. Additionally, configuration data may conflict with the inventory data list. Configuration data may be used to determine that an internal component that is supposed to be in server computing system 104 is not actually installed. The missing component may be removed from the model. Diagnostic vision program 114 may also add an indication (descriptive text, a symbol, etc.) to the model indicating that the component is missing. As an alternative, the missing component may remain in the model, but be marked in a way to indicate that it is missing from server computing system 104 (blinking, drawn in a different color, drawn with dashed lines, etc.).

Based on received diagnostic data, diagnostic vision program 114 may highlight, or otherwise indicate on the model, internal components causing problems. These indications may also provide a level of severity. For example, an internal component drawn in red might indicate severe problems, whereas an internal component drawn in yellow might indicate fleeting problems. Diagnostic vision program 114 may also associate metadata with certain components such that when a specific component is selected, information in the associated metadata may be displayed concurrently, and potentially overlaid, with the model. Metadata might include error messages, log scripts, temperature (provided by thermal sensors managed by a service processor), and component information such as serial numbers, install dates, and component addresses.

Based on feed images from inside server computing system 104, diagnostic vision program 114 may also modify parts of the model image with real-time internal images. Low-cost CCD (charge-coupled device) imagers may be placed inside server computing system 104 and may provide internal images to mobile device 102 when communication is initiated. The internal images may be a collection of still CCD images or full-motion video frames. A created photo or video stream can then be used to supplement the model with actual internal views. Additionally, these images can be compared to model specifications, inventory lists, and configuration data to determine if the actual components match the listed components. Diagnostic vision program 114 may indicate any discrepancies as discussed previously.

Diagnostic vision program 114 displays, on the screen of mobile device 102, one or more internal components of the three-dimensional model, as modified in response to the system information (step 210). If a specific internal component is selected, additional information related to the specific internal component may also be displayed. Such information may be stored in metadata associated with specific components. Diagnostic vision program 114 may determine a user has selected a component by receiving user input in the form of a screen touch corresponding to the display of an internal component. In another embodiment, diagnostic vision program 114 may display a pointer or cross-hairs on the screen, and any component pointed to or displayed within the cross-hairs may be considered “selected,” and additional information displayed. Users of skill in the art will also recognize that, in an alternative embodiment, instead of modifying the model as described above, it may actually be the displayed image of the model that is modified according to the same techniques. The displayed model may highlight various points-of-interest (such as internal components with errors), may cause such points-of-interest to flash, and may provide different indications and descriptions on the screen. Additionally, diagnostic vision program 114 may supplement the display with vibration and/or sound, for example when the cross-hairs near or cross a point-of-interest.

In a preferred embodiment, diagnostic vision program 114 displays the model relative to the physical location of mobile device 102 with regard to server computing system 104. The perspective of the displayed model, and navigation of the display, may be controlled by navigation program 116. The environment surrounding server computing system 104 may be displayed in a faded or translucent manner, or may be removed completely from the display. Based on a selection, or some other input, diagnostic vision program 114 may also move “inside” a component to display the components internal to the selected component. Diagnostic vision program 114 may, in such an embodiment, treat the selected component as the identified physical computer system. Diagnostic vision program 114 may also provide or indicate a direction to move a pointer or the mobile device in order to come closer to a point-of-interest. For example, an arrow may appear on the screen pointing towards the nearest point-of-interest.

FIG. 3 depicts navigation program 116 for displaying and navigating a three-dimensional augmented model of a physical computer system, in accordance with an embodiment of the present invention.

In an embodiment, navigation program 116 matches the perspective of the displayed model to server computing system 104 as viewed through a camera lens of mobile device 102 (step 302). For example, the three-dimensional model can be rotated, flipped, and/or resized such that the outer boundaries of the model match the outer boundaries of a real-time image of server computing system 104. Additionally, navigation program 116 may use known dimensions of the model to determine a side of server computing system 104 mobile device 102 is on, as well as angular displacement, and the distance between mobile device 102 and server computing system 104. In response, the display shows internal components, as arranged in server computing system 104, from the same perspective of mobile device 102's position in space around server computing system 104.

Navigation program 116 subsequently detects movement of mobile device 102 (step 304). Navigation program 116 can detect movement, and movement direction, in a number of different ways, including through use of accelerometers, gyroscopes, magnetometers, global positioning systems, and combinations of the preceding. While more accurate determinations of orientation and motion may come from the combination of more than one of these devices, due to cost and availability, the preferred embodiment uses only one or more accelerometers. Accelerometers measure acceleration, and from this can calculate distance moved. For example, the general equation for determining distance from acceleration is: Distance=Vₒ+½*a*t², where Vₒ is the initial velocity (in this situation, zero), ‘a’ is the measured acceleration, and ‘t’ is time. Additionally, because an accelerometer senses movement and gravity, it can also sense the angle at which it is being held. Single and multi-axis models of accelerometers are available to detect magnitude and direction of the proper acceleration (or g-force), as a vector quantity. Hence, mobile device 102's movement and position relative to server computing system 104 can be calculated.

If, during movement of mobile device 102, no displayed internal component is selected by the user (no branch, decision 306), navigation program 116 estimates a new perspective of the displayed model based on the movement of the mobile device (step 308), thus continuing the perception that the mobile device is looking inside server computing system 104.

Navigation program 116 synchronizes the displayed model with the real-world image of server computing system 104 (step 310). To account for accelerometer drift and various discrepancies in perspective estimates, navigation program 116 will periodically compare the model perspective to a real-time image of the system and adjust the displayed model accordingly. Low cost accelerometers often have a larger drift effect, and so may be synchronized more often. In one embodiment, the outer-boundaries of the displayed model are compared with the outer-boundaries of a real-time image of server computing system 104 as received through a camera of mobile device 102. In an alternate embodiment, the boundaries of an internal component shown on the displayed model may be compared to boundaries of real-time images from internal imaging devices of server computing system 104. Similar to the initial step of matching the perspective of the mobile device, angles and distance relative to system may be processed.

In one embodiment, if movement is detected while an internal component is selected (yes branch, decision 306), navigation program 116 determines if the direction mobile device 102 is moving is towards the selected internal component (decision 314). If mobile device 102 is not moving towards the selected internal component (no branch, decision 314), navigation program 116 may operate in the normal fashion, estimating a display perspective. If, however, navigation program 116 determines that mobile device 102 is moving towards the internal component (yes branch, decision 314), navigation program 116 displays the internal contents of the selected internal component (step 316). In one embodiment, a three-dimensional model of the internal component could be downloaded and displayed. In another embodiment, the “moving in” motion initiates diagnostic vision program 114 and provides the internal component to diagnostic vision program 114 as the identity of the system. Navigation program 116 continues to operate with the internal component as the displayed model. The selection may occur by the user pressing a button while a pointer or cross-hairs are on the internal component or by the user pressing the display/touch-screen where the internal component is displayed.

In the preferred embodiment, selecting a component for the display to move “inside” the component includes resting the pointer or cross-hairs on the displayed image of the component for a predefined threshold of time. For example, if cross-hairs are on a component, information pertaining to the component may be displayed. After a period of time (e.g. five seconds) on the same component, the cross-hairs may turn green to indicate that the inside of the component may now be viewed. Once the cross-hairs have turned green, moving mobile device 102 towards the component causes the augmented display to show the internal components of the selected component. The original system may disappear from view or become translucent. Other methods for selecting the component may be used.

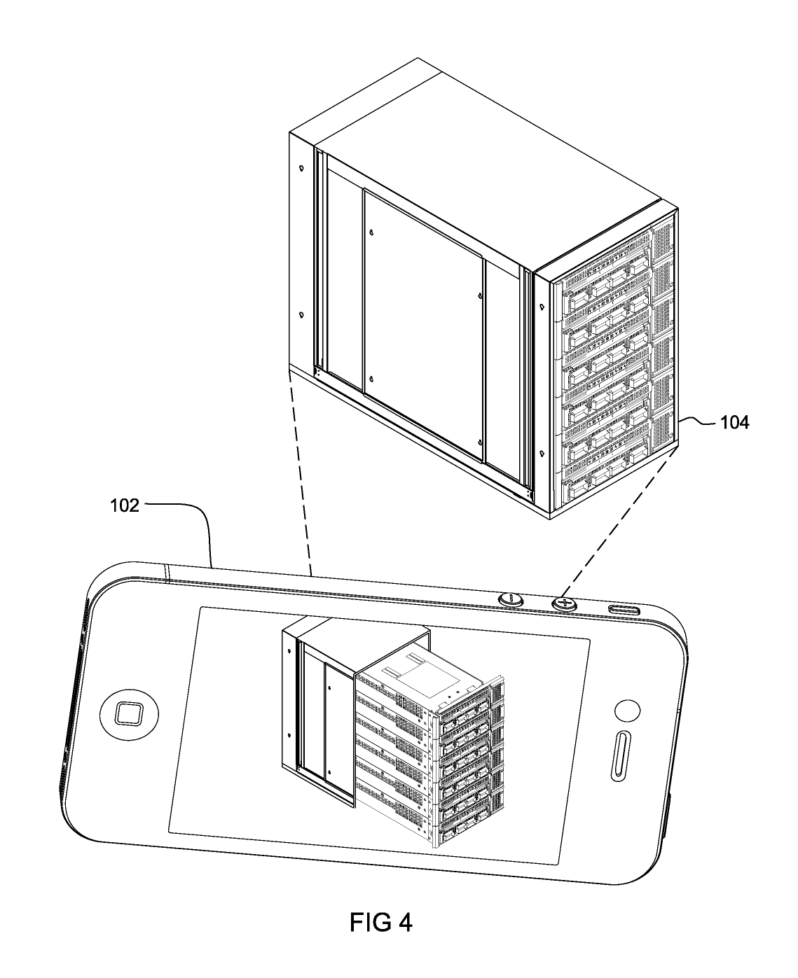

FIG. 4 depicts mobile device 102 displaying internal components of server computing system 104, in accordance with an embodiment of the present invention. As depicted, server computing system 104 is a blade chassis. In accordance with diagnostic vision program 114, a three-dimensional model depicting internal components of server computing system 104 is displayed from the perspective of the mobile device in relation to server computing system 104.

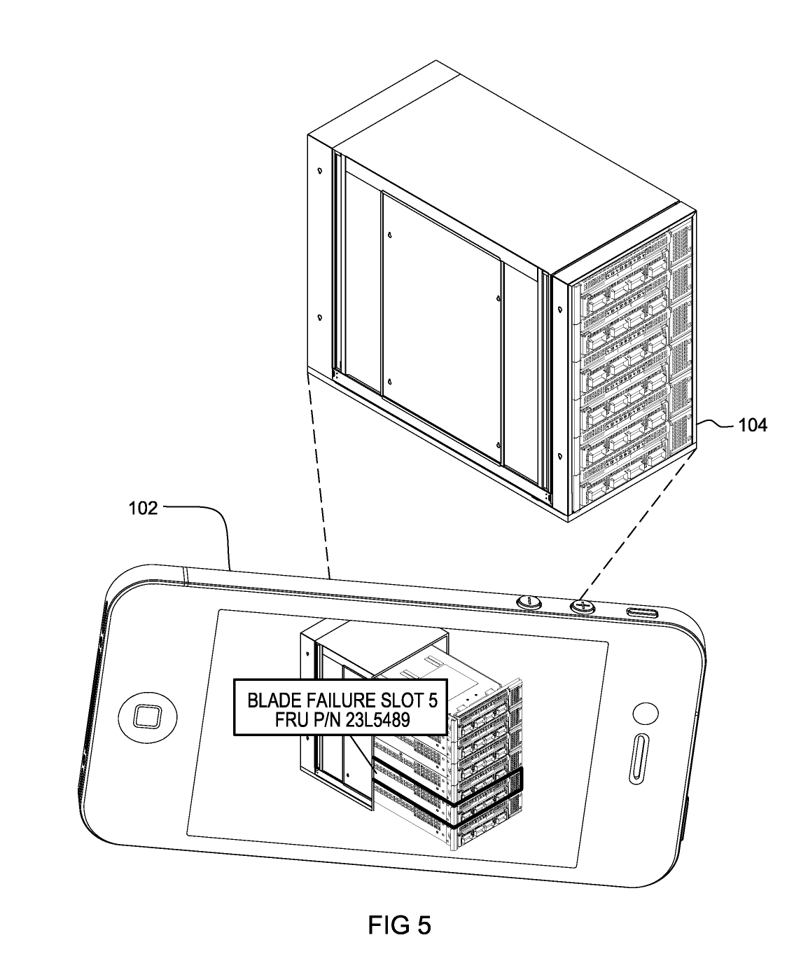

FIG. 5 illustrates the modification of the three-dimensional model based on diagnostic information, in accordance with an embodiment of the present invention. As depicted, mobile device 102 receives diagnostic data indicating the failure of a specific blade server, and highlights the failed server on the displayed model. Cross-hairs are depicted on the display, which when over the highlighted blade server, cause additional information to be displayed. Here, the displayed information includes the failure, the location, and a part number. Additionally, as the cross-hairs move over a point-of-interest, such as a failed component, they may cause mobile device 102 to vibrate, beep, or otherwise indicate the point-of-interest.

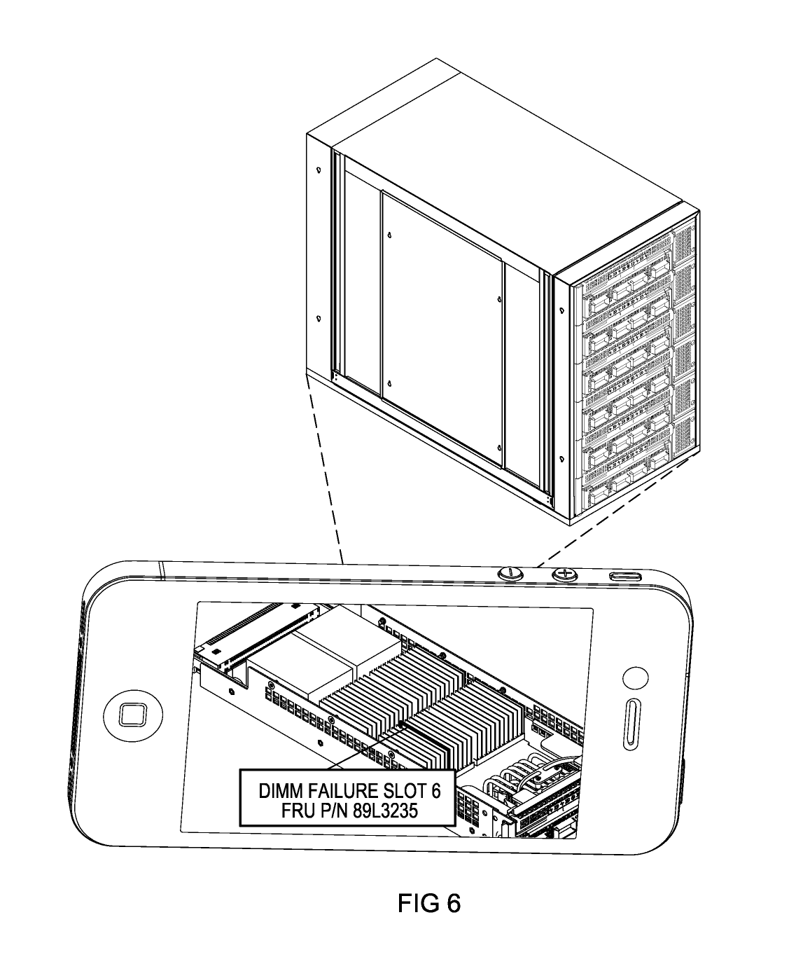

FIG. 6 depicts the display of internal components of the failed blade server, in accordance with an illustrative embodiment of the present invention. With the selection of the failed blade server, the display may move “inside” the blade server by displaying a three-dimensional model of the blade server. As previously discussed, the selection may occur by the user pressing a button while the cross-hairs are on the blade server, or by the user pressing the display/touch-screen on the blade server, or by the user moving the phone towards the blade server while the cross-hairs are on the blade server or it is otherwise selected. The internal components of the blade server are displayed and modified with diagnostic information. As depicted, a memory DIMM component has failed. Similar to the initial internal view of server computing system 104, additional information may be shown where the cross-hairs land on an internal component.

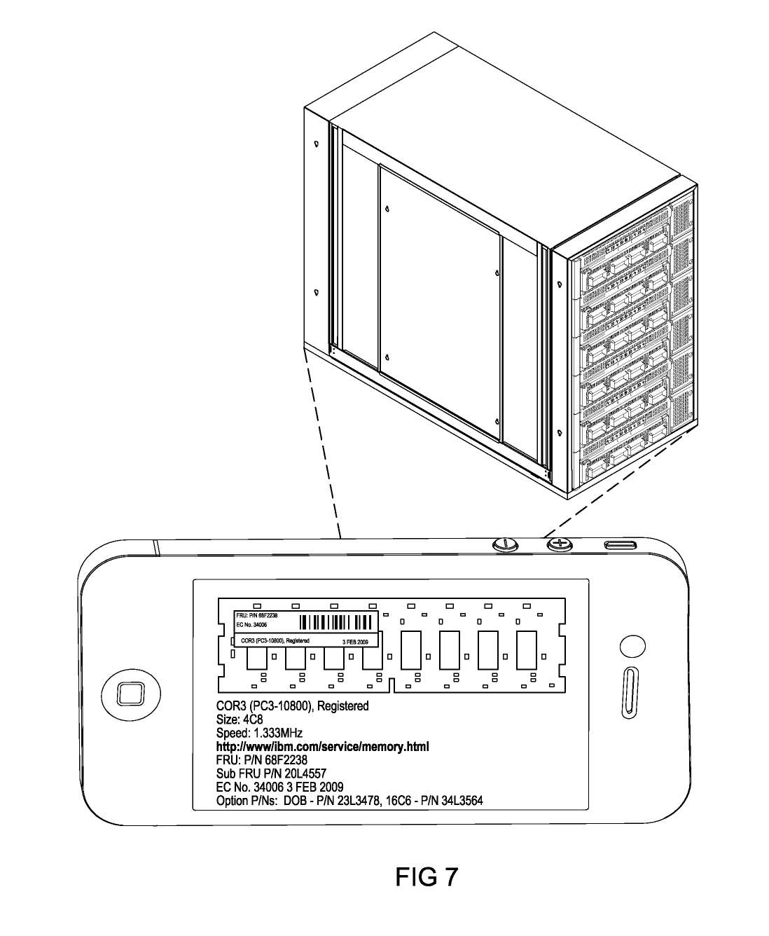

FIG. 7 depicts an alternate display of a selected component (e.g., the failed DIMM). If selected, a photo image of a part or component may be prominently displayed. Additional information may also be presented. For example, specifications of the component, web links to help diagnose the failure or purchasing sites, and/or event log files and other diagnostic data may be displayed. Part numbers of components that are supported by the system, possible replacement parts for example, may also be displayed.

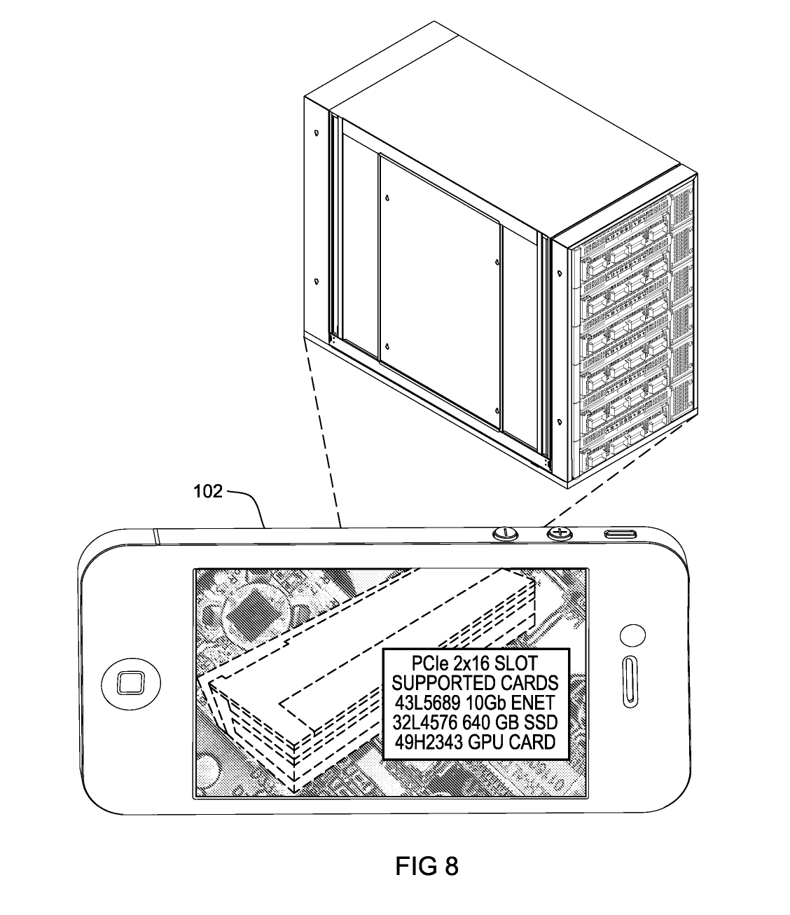

FIG. 8 illustrates the combination of an internal photo image and the three-dimensional model, in accordance with an embodiment of the present invention. As depicted, mobile device 102 switches to live images internal to the failed blade server. The live image depicts a motherboard for the blade server. Based on the image, mobile device 102 determines that two PCI slots are empty and augments models of possible PCI cards that may be installed. Additionally, mobile device 102 may determine that a specific component was supposed to be installed where none exists, and augment a model of the missing component with an indication that the component is not actually there.

FIG. 9 depicts a block diagram of components of mobile device 102, in accordance with an illustrative embodiment of the present invention. It should be appreciated that FIG. 9 provides only an illustration of one implementation and does not imply any limitations with regard to the environments in which different embodiments may be implemented. Many modifications to the depicted environment may be made.

Mobile device 102 includes communications fabric 902, which provides communications between computer processor(s) 904, memory 906, persistent storage 908, communications unit 910, and input/output (I/O) interface(s) 912. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 914 and cache memory 916. In general, memory 906 can include any suitable volatile or non-volatile computer-readable storage media.

Augmentation program 112, diagnostic vision program 114, and navigation program 116 are stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 910, in these examples, provides for communications with other data processing systems or devices, for example server computing system 104 and server computer 106. In these examples, communications unit 910 includes one or more network interface cards and one or more near field communication devices. Communications unit 910 may provide communications through the use of either or both physical and wireless communications links. Computer programs and processes may be downloaded to persistent storage 908 through communications unit 910.

I/O interface(s) 912 allows for input and output of data with other devices that may be connected to mobile device 102. For example, I/O interface 912 may provide a connection to external devices 918 such as a keyboard, keypad, a touch screen, a camera, and/or some other suitable input device. External devices 918 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 908 via I/O interface(s) 912. I/O interface(s) 912 may also connect to a display 920.

Display 920 provides a mechanism to display data to a user and may be, for example, an embedded display screen or touch screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for virtually seeing inside a computer system, the method comprising:
identifying, via a mobile device, a physical computing system;
retrieving a three dimensional model corresponding to the physical computing system, wherein the three dimensional model includes an arrangement of internal components;
receiving real-time system information from the physical computing system;
modifying an image of the three dimensional model based on the real-time system information; and
displaying, on the mobile device, at least a portion of the modified image, including one or more internal components.

2. The method of claim 1, wherein said identifying the physical computing system comprises:
receiving an image of at least a portion of the physical computing system via a camera coupled to the mobile device; and
matching the image of at least the portion of the physical computing system to a known system.

3. The method of claim 1, wherein said receiving the real-time system information comprises:
receiving system information from one or more of the group consisting of: diagnostic data from the physical computing system, customer configuration data, inventory data, pictures from a camera internal to the physical computing system, video from a camera internal to the physical computing system.

4. The method of claim 1, wherein said receiving the real-time system information comprises:
accessing a service processor of the physical computing system; and
requesting system information from the service processor.

5. The method of claim 1, wherein said modifying the image of the three dimensional model based on the real-time system information comprises, indicating one or more failing internal components or internal components experiencing errors.

6. The method of claim 1, wherein said modifying the image of the three dimensional model based on the real-time system information comprises, indicating a missing internal component.

7. The method of claim 1, wherein said modifying the image of the three dimensional model based on the real-time system information comprises, rearranging one or more internal components of the three dimensional model.

8. The method of claim 1, wherein said displaying at least the portion of the modified image, including one or more internal components, comprises, displaying the modified image from the perspective of the mobile device relative to the physical computing system.

9. The method of claim 1, further comprising, displaying, on the mobile device, additional information associated with a selected displayed component.

10. The method of claim 1, further comprising, displaying on the mobile device, an icon, which can be used to select a displayed component when at least a portion of the icon is on the displayed component.

11. The method of claim 1, further comprising:
receiving an indication to display internal components of a displayed component, and in response, displaying internal components of the displayed component.

12. A method for navigating a display of a three dimensional model corresponding to a computer system, the method comprising:
displaying, on a mobile device, an image of a three dimensional model corresponding to a computer system in line-of-sight with the mobile device, wherein the image of the three dimensional model is displayed from the perspective of the mobile device relative to the computer system;
detecting movement of the mobile device;
based on the detected movement, adjusting the image of the three dimensional model such that the image of the three dimensional model is displayed from a new perspective of the mobile device relative to the computer system; and
based on an image received at the mobile device of the computer system, synchronizing the displayed image to match the image of the computer system.

13. The method of claim 12, wherein said displaying the image of the three dimensional model corresponding to a computer system in line-of-sight with the mobile device comprises:
receiving an image of the computer system via a camera attached to the mobile device;
manipulating size and perspective of the three dimensional model image to match the image of the computer system; and
displaying the manipulated image.

14. The method of claim 12, wherein said detecting movement of the mobile device comprises:
calculating distance and direction of the movement and position of the mobile device using one or more accelerometers.

15. The method of claim 14, wherein said synchronizing the displayed image to match the image of the computer system comprises, synchronizing the displayed image to match a current image of the computer system at a specified interval, wherein the specified interval is dependent on acceleration drift of at least one of the one or more accelerometers.

16. The method of claim 12, wherein the image of the three dimensional model is modified by system information received from the computer system.

17. The method of claim 12, further comprising, displaying an icon indicating a point of focus in the image.

18. The method of claim 17, further comprising:
determining that the point of focus is on a component of the three dimensional model displayed in the image, and in response, displaying information related to the component.

19. The method of claim 17, further comprising:
determining that the point of focus is on a component of the three dimensional model displayed in the image;
determining that the component is a potential point of interest to a user; and
providing an indication to the user of the potential point of interest, the indication selected from the group consisting of: playing an audible sound, vibrating the mobile device, causing a displayed image of the component to pulse or blink, and changing a color of the displayed component.

20. The method of claim 17, further comprising:
determining that the point of focus is on a component of the three dimensional model displayed in the image;
detecting movement of the mobile device; and
determining the movement is towards the component, and in response, displaying internal components of the component.
